(19) United States
(12) Patent Application Publication
(10) Pub. No.: US 2011/0048873 A1
(43) Pub. Date: Mar. 3, 2011

(54) STRUCTURE OF HYDRAULIC BRAKE LEVER ASSEMBLY

(76) Inventor: CHI F. WANG, San Marino, CA (US)

(21) Appl. No.: 12/549,383

(22) Filed: Aug. 28, 2009

(51) Int. Cl. F16D 55/26

(52) U.S. Cl. 188/72.6

(57) ABSTRACT

A hydraulic brake lever assembly includes a hollow lever mount accommodating therein a hydraulic pump. Two window openings are respectively formed in opposite sides of a middle section of the lever mount and in communication with an interior space of the lever mount. The hydraulic pump includes an outer cylinder member and an inner bore member arranged inside the outer cylinder member to define a hydraulic fluid chamber therebetween. An in-flow passage is defined in a wall of the inner bore member to communicate a bore defined in the inner bore member. A spring-biased piston is movably received in the bore of the inner bore member. The piston is driven by a driving bar coupled to a handgrip. The outer cylinder member forms in a wall thereof a hole receiving and in threading engagement with a transparent plug that is exposed through each of the window openings.

### (a) TECHNICAL FIELD OF THE INVENTION

The present invention generally relates to a structure of hydraulic brake lever assembly that is formed in an inside-accommodated configuration to eliminate invasion of air for ensuring better protection.

### (b) DESCRIPTION OF THE PRIOR ART

Taiwan Patent No. 1294388 issued in Mar. 11, 2008 discloses a brake lever and an adjustment device thereof wherein a mount 10 is coupled internally a hydraulic control set 30. A fluid tank 11 extends above the mount and the fluid tank 11 comprises a fluid inlet opening 12 communicating an interior space of the mount 10, whereby the hydraulic control set 30 controls the brake operation realized through the fluid inlet opening.

The hydraulic tank 11 is structured to directly extend from the mount 10 and is covered by a lid that is secured by bolts, so that the hydraulic tank is exposed above the mount 10 and is thus susceptible to invasion of air that forms air bubbles that might deteriorates the brake operation and thus threatens riding safety. Further, hole drilling must be carried out first and then bolt securing can be done. This makes the assembling inconvenient for the parts are not allowed to individually remove. Thus, when any of the parts is broken, the whole assembly must be replaced. This increases the costs of maintenance.

Thus, the present invention aims to solve the problems of the conventional devices of being susceptible to invasion of air that leads to deterioration of brake operation and having high costs of assembling, repairing and maintenance.

### SUMMARY OF THE INVENTION

An objective of the present invention is to provide an inside accommodated construction of hydraulic brake lever assembly that arranges a hydraulic pump inside a lever mount to eliminate invasion of air so as to ensure preciseness and reliability of brake operation for improved safety.

Another objective of the present invention is to provide a hydraulic brake lever assembly that is formed by simple and direct assembling a mass-produced hydraulic so as to realize efficient assembling and to allow simple replacement of a broken part without the need of replacing the whole assembly, in case of malfunctioning, whereby maintenance costs of the hydraulic brake lever assembly is effectively reduced.

A further objective of the present invention is to provide a hydraulic brake lever assembly that allows for easy inspection of internal hydraulic fluid through an external window and also allows for colorful combinations of a lever mount and a hydraulic pump that are made of different colors so as to enhance visual aesthetics.

To achieve the above objectives, the present invention provides a lever mount comprising a barrel-like body forming a bore having a reduced end opening and an opposite end opening from sides of which a pivot joint section for pivotally jointing a brake lever and a clamp ring for mounting to a handlebar project. The lever mount forms in opposite sides thereof window openings in communication with the bore. A master hydraulic pump is accommodated in the bore of the lever mount and comprises an outer cylinder member, an inner bore member, and a piston. The outer cylinder member forms a channel having an end section forming an internal thread. The inner bore member has an external thread section set in engagement with the outer cylinder member and partially projects beyond the reduced end opening to engage an internally threaded fastener member, whereby a hydraulic fluid chamber is defined between the outer cylinder member and the inner bore member. An in-flow passage is defined in a wall of the inner bore member communicating between the hydraulic fluid chamber and a bore defined in the inner bore member. The outer cylinder member forms a fluid charge opening in a wall thereof for communication with the hydraulic fluid chamber and removably closed by a lid and further defines one or two opposite internally-threaded holes at locations circumferentially shifted away from the fluid charge opening and in communication with the hydraulic fluid chamber for receiving, in threading engagement a transparent plug for visual inspection of the fluid contained inside the hydraulic fluid chamber. The inner bore member receives therein a piston that is coupled to a resilient element. The piston has a circumferential surface to which two sealing rings are mounted in a spaced manner. The piston has an outer end forming a socket for receiving and forming a driving coupling with an end of a driving bar that is retained in position by a retention plate. An opposite end of the driving bar is rotatably coupled to a brake lever by means of a rotatable connection sub-assembly.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a hydraulic brake lever assembly in accordance with the present invention.

FIG. 2 is a perspective view of the hydraulic brake lever assembly of the present invention in an assembled form.

FIG. 3 is a cross-sectional view of the hydraulic brake lever assembly of the present invention, showing the hydraulic brake lever assembly in a non-actuated condition.

FIG. 4 is also a cross-sectional view of the hydraulic brake lever assembly of the present invention in an actuated condition.

FIG. 5 is an enlarged cross-sectional view of a portion of the hydraulic brake lever assembly of the present invention taken along a different section.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

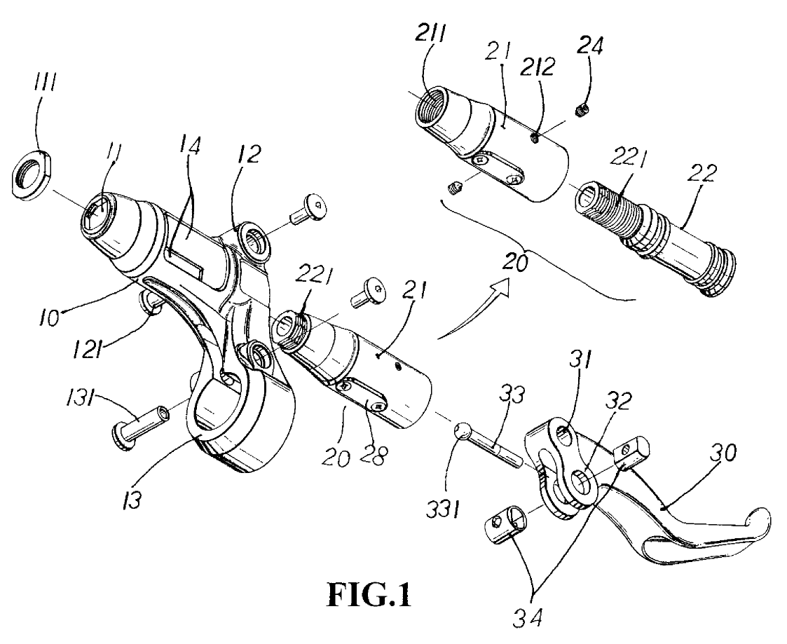

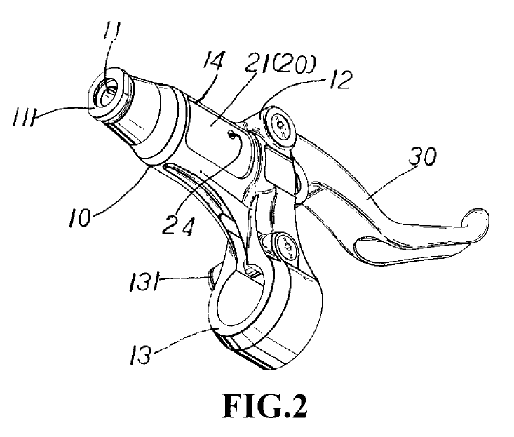

As shown in FIGS. 1-3, a hydraulic brake lever assembly according to an embodiment of the present invention is composed of a lever mount 10, a master hydraulic pump 20, and a brake lever 30.

The lever mount 10 comprises a barrel-like body through which a bore is formed. The bore has a reduced opening 11 defined in an end of the body and an opposite opening defined an opposite end of the body. A pivot joint section 12 extends sideways from one side of the opposite end opening for pivotally jointing the brake lever 30 and a clamp ring 13, to which a fastener pin 131 is fit, extends sideways from an opposite side of said opposite end opening for mounting to a handlebar of for example a bicycle. Window openings 14 of a proper width are respectively defined in opposite sides of a middle section of the body and in communication with the bore.

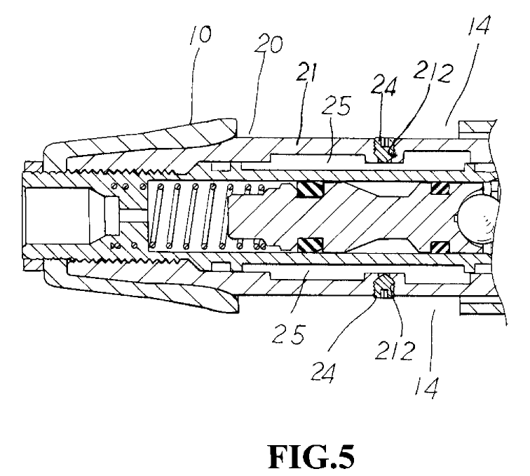

The master hydraulic pump 20 is arranged inside the barrel-like body of the lever mount 10 and comprises an outer cylinder member 21, an inner bore member 22, and a rod-like piston 23. The outer cylinder member 21 comprises a cylindrical body forming an internal channel that has an end section forming an internal thread 211 for threading engagement with an external thread section 221 of the inner bore member 22 received in the channel of the outer cylinder member 21 so that an end portion of the external thread section 221 of the inner bore member 22 projects beyond the reduced opening 11 of the lever mount 10 for engagement with an inner-threaded fastener member 111 and thus being fixed for the purposes of connection with a hydraulic conduit (not shown). A hydraulic fluid chamber 25 is formed between the outer cylinder member 21 and the inner bore member 22. The hydraulic fluid chamber 25 is in communication with a fluid in-flow opening 26 defined in the inner bore member 22 for further communication with a bore defined in the inner bore member 22. The outer cylinder member 21 has a circumferential wall forming a fluid charge opening 27, which communicates the hydraulic fluid chamber 25 and receives a lid 28 mounted thereto by means of for example bolt for shielding and closing. An inner flange 222 is formed in the bore of the inner bore member 22 to support the piston 23 that is coupled to a resilient element 231. The piston 23 has an outer circumferential surface to which two sealing rings 232 are mounted in a spaced manner for engagement with an inside surface of the bore of the inner bore member 22 in a fluid sealed manner. The piston 23 has an outer end forming a socket 233. Also referring to FIG. 5, one or two internally-threaded holes 212 are defined through the circumferential wall of the outer cylinder member 21 at locations corresponding to the window openings 14 on the opposite sides of lever mount 10 and circumferentially shifted away from the fluid charge opening 27 to communicate the hydraulic fluid chamber 25. Transparent plugs 24 are mounted in the holes 212 with threading engagement. This arrangement provides windows for convenient inspection of fluid level inside the hydraulic fluid chamber 25 of the master hydraulic pump 20 and also provides, under the condition that the window openings 14 have a sufficient width, a colorful combination of the lever mount 10 and the master hydraulic pump 20 that are made with different colors to thereby enhance visual aesthetics.

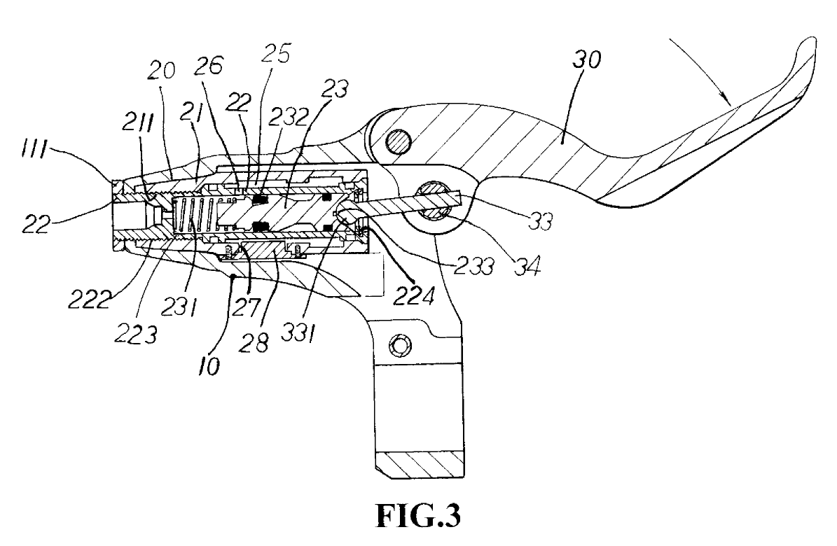

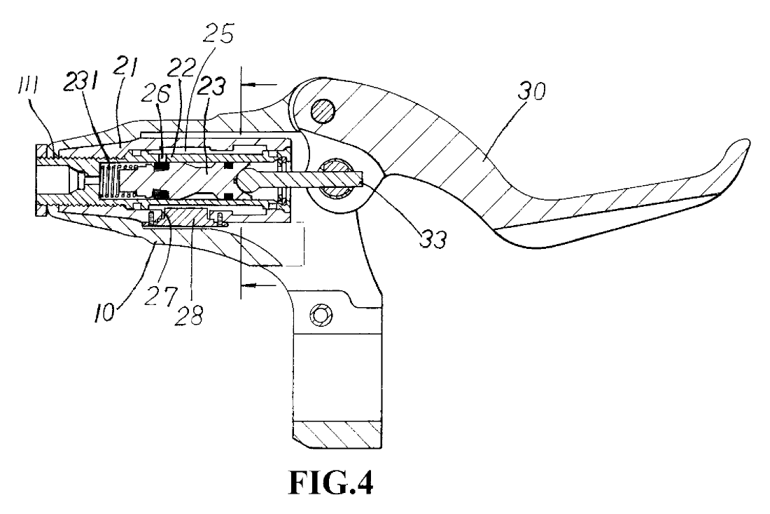

The brake lever 30 comprises a handgrip portion and an end that is opposite to the handgrip portion and forms a pivot hole 31 that receives a pivot pin 121 therein for pivotally jointing to the pivot joint section 12 of the lever mount 10. Two lugs 32 extend sideways from a side of the pivot hole 31 and define aligned holes for rotatably receiving a rotatable connection sub-assembly 34 that is mounted to an outer end of a driving bar 33. The driving bar 33 has an opposite end forming a sphere 331 that is received and retained in the socket 233 of the piston 23 by a retention plate 224 so as to allow the brake lever 30 to drive the driving bar 33 to cause movement of the piston 23 inside the inner bore member 22 for selectively opening/closing the fluid in-flow opening 26, as shown in FIGS. 3 and 4, to effect brake operation.

As shown in FIG. 3, the present invention arranges the master hydraulic pump 20 inside the barrel-like body of the lever mount 10 to be secured by a fastener member 111. The two transparent plugs 24 on opposite sides are arranged to expose through the window openings 14 on the opposite sides of the lever mount 10. The fluid charge opening 27 and the lid 28 are completely shielded by the lever mount 10 and concealed therein. The driving bar 33 that is pivotally coupled to the brake lever 30 extends into the 22 of the master hydraulic pump 20 with the spherical end 331 thereof positioned against the socket 233 of the piston 23. The spherical end 331 of the driving bar 33 is set and retained in position by the retention plate 224 set in the end opening of the inner bore member 22. As such, a hydraulic brake lever assembly is formed in an efficient manner. The lever mount 10 forms an interior hollow space that is sufficient to completely accommodate the master hydraulic pump 20 to provide an inside accommodated assembly, whereby the hydraulic fluid chamber 25, the fluid charge opening 27, and the lid 28 are completely concealed inside the lever mount 10. Air invasion due to exposure of the hydraulic fluid chamber 25 is eliminated, preciseness and reliability of brake operation can be ensured, and driving/riding safety can be improved. When the hydraulic brake lever assembly is broken, repairing can be done by simply replacing only the broken parts, such as brake lever 30 and the master hydraulic pump 2. Further, depending whether a broken portion occurs in the outer cylinder member 21 or the inner bore member 22, a malfunctioning master hydraulic pump 20 can be repaired without replacement by a new one. This effectively reduces the costs for maintenance.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A hydraulic brake lever assembly, comprising:
a lever mount, which comprises a barrel-like body defining therethrough a bore having a reduced end opening and an opposite end opening, a pivot joint section projecting sideways from one side of the opposite end opening, a clamp ring extending sideways from a side of the opposite end opening for mounting to a handlebar;
a master hydraulic pump, which is received in the bore of the lever mount and defines therein a bore that receives a piston;
a brake lever, which is pivotally jointed to the pivot joint section of the lever mount, a driving bar being rotatably coupled to the brake lever and having an end extending into the master hydraulic pump to form a driving coupling with the piston so that the brake lever is allowed to drive the piston of the master hydraulic pump to effect brake operation.

2. The hydraulic brake lever assembly according to claim 1, wherein the master hydraulic pump comprises an outer cylinder member and an inner bore member that defines the bore of the master hydraulic pump for movably receiving the piston therein, the outer cylinder member forming an internal channel having an end section forming an internal thread, the inner bore member forming an external thread section at an end thereof to be fit into and forming threading engagement with the channel of the outer cylinder member so that an end portion of the external thread section of the inner bore member projects beyond the lever mount for engagement with and thus secured by an inner-threaded fastener member.

3. The hydraulic brake lever assembly according to claim 2, wherein the outer cylinder member and the inner bore member form therebetween a hydraulic fluid chamber that is in communication with a fluid in-flow opening defined in a wall of the inner bore member for further communication with the bore defined in the inner bore member, wherein the outer cylinder member has a circumferential wall forming a fluid charge opening, which communicates the hydraulic fluid chamber and is closed by a removable lid, and wherein the bore defined in the inner bore member forms an inner flange to support the piston that is coupled to a resilient element, the piston having an outer circumferential surface to which two sealing rings are mounted in a spaced manner.

4. The hydraulic brake lever assembly according to claim 3, wherein the brake lever forms two lugs extending sideways opposite to the pivot joint section of the lever mount and defining aligned holes for rotatably receiving a rotatable connection sub-assembly that is mounted to an outer end of the driving bar, the driving bar having an opposite end forming a sphere that extends into the master hydraulic pump to be received and retained in a socket defined in an end of the piston, a retention plate being set in an open end of the inner bore member to retain the spherical end of the driving bar in position.

5. The hydraulic brake lever assembly according to claim 2, wherein one or two opposite sides of the lever mount form a window opening in communication with the bore of the lever mount, an internally-threaded hole being defined in the wall of the outer cylinder member at a location corresponding to the window opening and in communication with the hydraulic fluid chamber for receiving and threading engagement with a transparent plug for inspection of fluid contained in the hydraulic fluid chamber.

6. The hydraulic brake lever assembly according to claim 3, wherein one or two opposite sides of the lever mount form a window opening in communication with the bore of the lever mount an internally-threaded hole being defined in the wall of the outer cylinder member at a location corresponding to the window opening and in communication with the hydraulic fluid chamber for receiving and threading engagement with a transparent plug for inspection of fluid contained in the hydraulic fluid chamber.

7. The hydraulic brake lever assembly according to claim 4, wherein one or two opposite sides of the lever mount form a window opening in communication with the bore of the lever mount, an internally-threaded hole being defined in the wall of the outer cylinder member at a location corresponding to the window opening and in communication with the hydraulic fluid chamber for receiving and threading engagement with a transparent plug for inspection of fluid contained in the hydraulic fluid chamber.
